(19) United States
(12) Patent Application Publication
(10) Pub. No.: US 2013/0106793 A1
(43) Pub. Date: May 2, 2013

(54) REPLACEABLE TOUCH PEN

(71) Applicant: Chao-Chi LAI, New Taipei City (TW)

(72) Inventor: Chao-Chi LAI, New Taipei City (TW)

(21) Appl. No.: 13/284,093

(22) Filed: Oct. 28, 2011

(51) Int. Cl. G06F 3/033

(52) U.S. Cl. 345/179

(57) ABSTRACT

A replaceable touch pen is provided with an electro-conductive barrel, the front end of the electro-conductive barrel is connected with an annular fixing member. The fixing member is locked at the front end of the electro-conductive barrel by snapping or screwing. The other end of the fixing member locks an electro-conductive nib through a tight-fitting method. The electro-conductive nib is an elastic material and can avoid the damage to an electronic device by an inappropriate force when a user is operating the touch pen. When the electro-conductive nib is worn out, broken or is to be replaced by a nib of a different size, the fixing member can be dismantled to rapidly and easily replace the electro-conductive nib at any time.

### BACKGROUND OF THE INVENTION

a) Field of the Invention The present invention relates to a replaceable touch pen, and more particularly to a replaceable touch pen having an electro-conductive nib that can be held stably and replaced rapidly and easily at any time.

b) Description of the Prior Art

A conventional PDA (Personal Digital Assistant) is actually a simple electronic note book, with functions similar to those of a universal note book used often by an office worker to manage businesses, numbers, texts, addresses and phones that usually need to be taken care of or recorded, so that people can work more efficiently and can carry more information personally. After being developed for a long time and combined with the computer, the current PDA has already become a mobile device allowing people to communicate, connect and interact on the internet. In addition, due to that the size, weight and effect of energy saving are all better than a note book computer, the PDA has become the mainstream product in the information era.

Referring to FIG. 1, it shows a schematic view of a conventional personal digital mobile device, wherein the personal digital mobile device (or PDA) 100 is characterized primarily in compactness. Hence, such as a keyboard of the note book computer can be omitted and is replaced by a touch screen 101 to input data and click on windows. However, it is truly difficult to use a finger to press and click on the small touch screen 101, and therefore, the conventional PDA is usually equipped with a touch pen, allowing a user to use the touch pen to control and point and click. Nevertheless, the conventional view screen or touch screen 101 is not able to bear with too large a pressure otherwise the screen can be squashed, leaving dark marks of damage on the screen.

Yet, the conventional touch pen is used to provide the user to exert a force on a barrel to result in a larger downward pressure to a tip, by a force arm effect of the barrel. Therefore, if the user exerts too large the force onto the tip, the touch screen 101 can be squashed. In particular, as the tip contacts the touch screen 101 of a PDA at dots, the degree of deformation by squashing will be more severe and even the tip can be fractured so that the nib cannot be replaced and the entire pen will be discarded for a new one. Therefore, it is imperative to design a kind of touch pen which can relax the pressure of the hand and allow the user to replace the nib easily at any time.

Accordingly, there are still a lot of shortcomings for the abovementioned touch pin which is indeed not a good design and thus needs to be improved.

### SUMMARY OF THE INVENTION

The primary object of the present invention is to provide a replaceable touch pen, wherein through the provision of a fixing member and an electro-conductive nib, the electro-conductive nib can be locked on the fixing member by a tight-fitting method. In addition, after the fixing member has been dismantled, the electro-conductive nib can be replaced, allowing the electro-conductive nib to be replaced rapidly and easily.

Another object of the present invention is to provide a replaceable touch pen, wherein as the electro-conductive nib is made by an elastic material, the electronic device (screen) can be prevented from being damaged by the user who exerts too much a force during operation.

To achieve the abovementioned objects, the present invention includes an electro-conductive barrel, a front end of the electro-conductive barrel is formed with a connection portion; a fixing member which is an annular and hollow structure, an end of the fixing member is interconnected and locked with the connection portion of the electro-conductive barrel and the other end of the fixing member locks the electro-conductive nib through the tight-fitting method, allowing the electro-conductive nib to be stably connected on the electro-conductive barrel.

In one embodiment of the present invention, the electro-conductive barrel is made by a plastic material.

In one embodiment of the present invention, the color of the electro-conductive barrel can be changed through conducting paint.

In one embodiment of the present invention, the electro-conductive barrel can be in a triangular, circular or rectangular shape.

In one embodiment of the present invention, the outer rim of the electro-conductive barrel can be connected with a clipping member. A slit is formed between the clipping member and the electro-conductive barrel to provide the user to clip and fix the electro-conductive barrel on a clothes.

In one embodiment of the present invention, the fixing member is interconnected with the electro-conductive barrel by snapping or screwing.

In one embodiment of the present invention, the front end of the electro-conductive barrel is covered by a cap.

In one embodiment of the present invention, the electro-conductive nib is extended with an extension portion and the fixing member is bended with a positioning portion corresponding to the extension portion. Through positioning and fixing the extension portion with the positioning portion, the electro-conductive nib is fixed at the front end of the electro-conductive barrel.

In one embodiment of the present invention, the electro-conductive nib can be divided into a small size, a medium size and a large size.

To enable a further understanding of the said objectives and the technological methods of the invention herein, the brief description of the drawings below is followed by the detailed description of the preferred embodiments.

### BRIEF DESCRIPTION OF THE DRAWINGS

FIG. 1 shows a schematic view of a conventional personal digital mobile device.

FIG. 2 shows a three-dimensional exploded view of a replaceable touch pen, according to the present invention.

FIG. 3 shows a three-dimensional view of an electro-conductive nib and an electro-conductive barrel of the replaceable touch pen, according to the present invention.

FIG. 4 shows a three-dimensional structural view of the replaceable touch pen after being assembled, according to the present invention.

FIG. 5 shows another three-dimensional structural view of the replaceable touch pen, according to the present invention.

FIG. 6 shows a three-dimensional schematic view of an implementation of the replaceable touch pen, according to the present invention.

FIG. 7 shows a three-dimensional exploded view of another replaceable touch pen, according to the present invention.

FIG. 8 shows a three-dimensional schematic view of another replaceable touch pen after being assembled, according to the present invention.

FIG. 9A shows a schematic view of a small-sized electro-conductive nib of the replaceable touch pen, according to the present invention.

FIG. 9B shows a schematic view of a medium-sized electro-conductive nib of the replaceable touch pen, according to the present invention.

FIG. 9C shows a schematic view of a large-sized electro-conductive nib of the replaceable touch pen, according to the present invention.

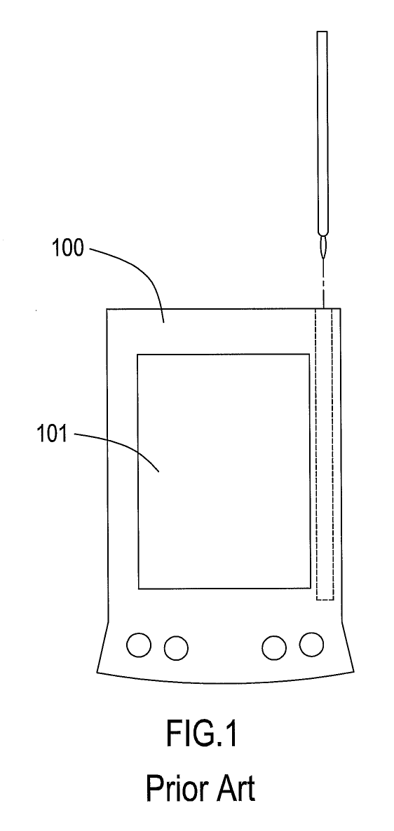

### DETAILED DESCRIPTION OF THE PREFERRED EMBODIMENTS

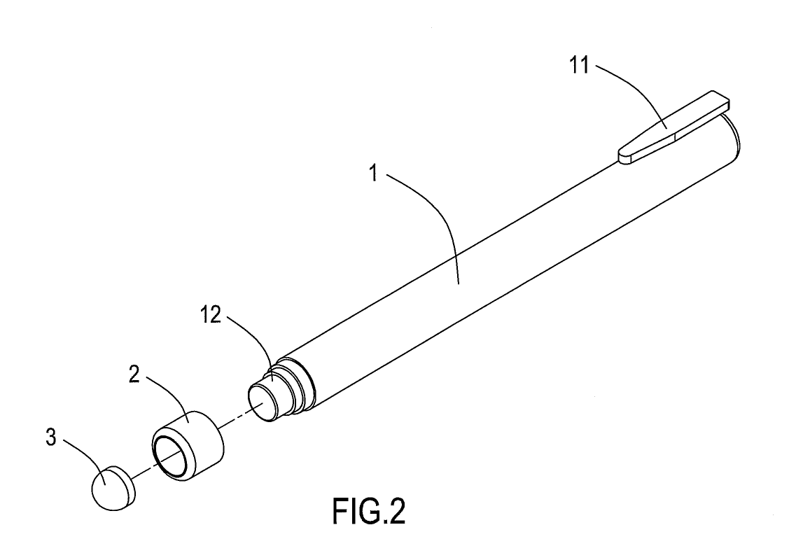

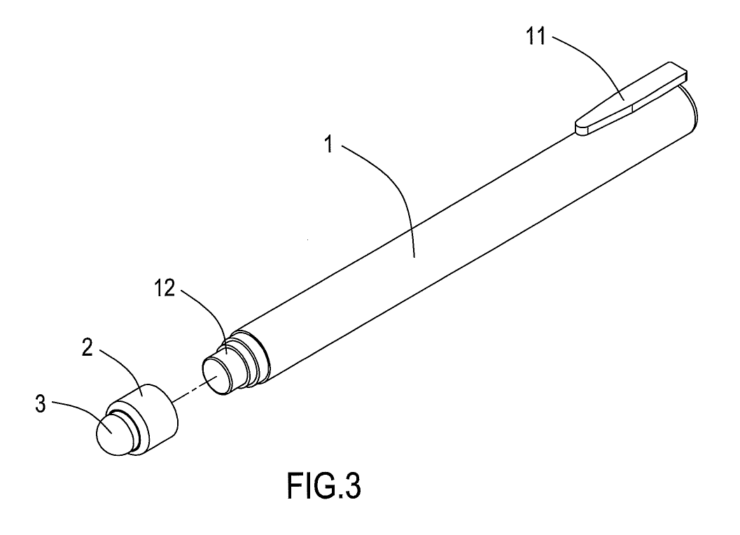

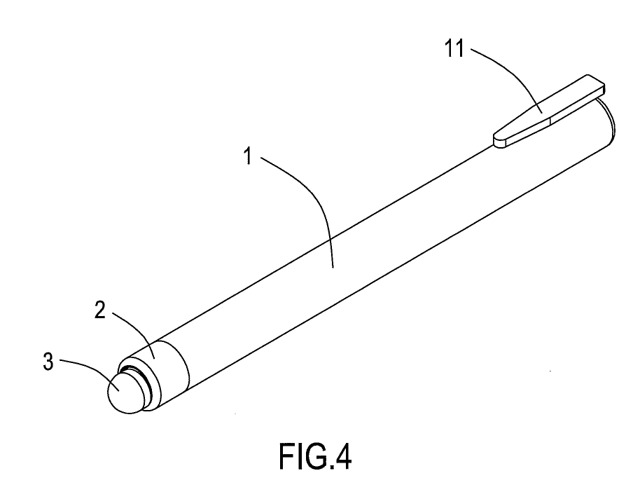

Referring to FIGS. 2 to 4, it shows the three-dimensional exploded view, the three-dimensional schematic view and the three-dimensional assembly view of a replaceable touch pen, according to the present invention. The replaceable touch pen comprises an electro-conductive barrel 1, a fixing member 2 and an electro-conductive nib 3.

The electro-conductive barrel 1 is made by a plastic material and the color of the electro-conductive barrel 1 can be changed through conducting paint to increase the diversity of color of the electro-conductive barrel 1. In addition to being in a circular shape as shown in the drawings, the electro-conductive barrel 1 can be in a triangular or rectangular shape to increase the practicality of the product. The outer rim of the electro-conductive barrel 1 can be connected with a clipping member 11 and a slit is formed between the clipping member 11 and the electro-conductive barrel 1, allowing a user to clip and fix the electro-conductive barrel 1 on a clothes. The front end of the electro-conductive barrel 1 is formed with a connection portion 12.

The fixing member 2 is an annular and hollow structure. An end of the fixing member 2 is interconnected and locked with the connection portion 12 of the electro-conductive barrel 1 by snapping or screwing, allowing the fixing member 2 to be connected and locked at the front end of the electro-conductive barrel 1. The other end of the fixing member 2, on the other hand, locks the electro-conductive nib 3 through a tight-fitting method, allowing the electro-conductive nib 3 to be stably connected on the electro-conductive barrel 1.

The electro-conductive nib 3 is made by an elastic material, such as electro-conductive plastic, electro-conductive rubber or electro-conductive foam. The electro-conductive nib 3 is locked on the fixing member 2 through the tight-fitting method.

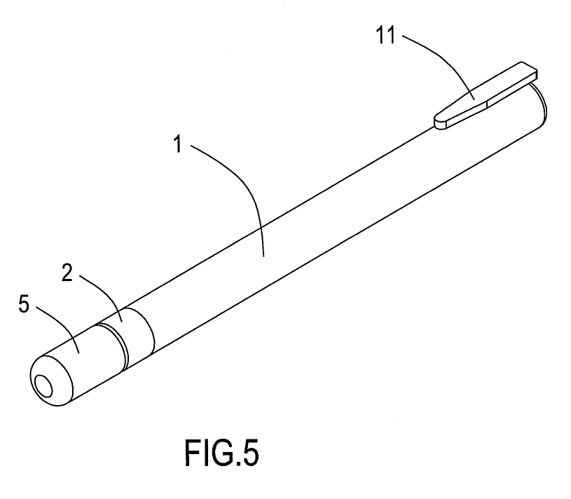

Referring to FIG. 5, it shows another three-dimensional structural view of the replaceable touch pen, according to the present invention. In the present embodiment, the front end of the electro-conductive barrel 1 can be locked with a cap 5, so that the electro-conductive nib 3 (not shown in the drawings) can be shielded and covered by the cap 3 to avoid exposing the electro-conductive nib 3 to speed up abrasion or collision, thereby extending the lifetime of use.

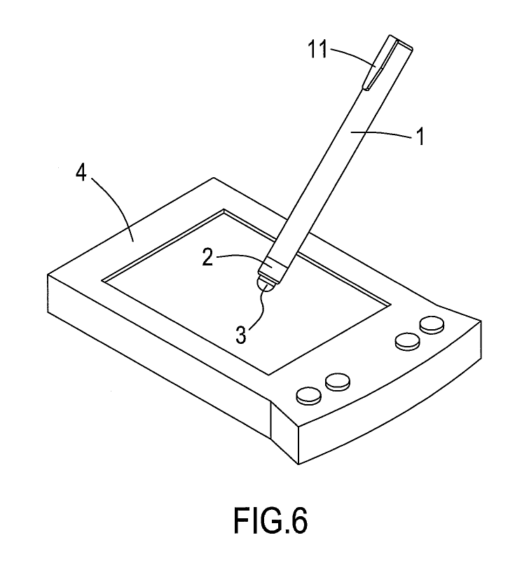

Referring to FIG. 6, it shows a three-dimensional schematic view of an implementation of the replaceable touch pen, according to the present invention. When the user is operating, he or she holds the electro-conductive barrel 1 and touches an electronic device 4 (screen) through the electro-conductive nib 3, allowing electricity to be conducted between the electro-conductive nib 3 and the screen, so that the electronic device 4 can be controlled. Besides, as the electro-conductive nib 3 is made by an elastic material, it will be worn out or broken easily after being used for a long time. If the electro-conductive nib 3 is worn out or broken, then the user only needs to dismantle fixing member 2 to replace the electro-conductive nib 3, followed by locking back the fixing member 2. Accordingly, a touch pen with the electro-conductive nib 3 that can be replaced rapidly and easily can be formed. In particular, as the touch nibs of various diameters can be replaced for different touch positions or different purposes, the shortcoming of using a single nib is solved.

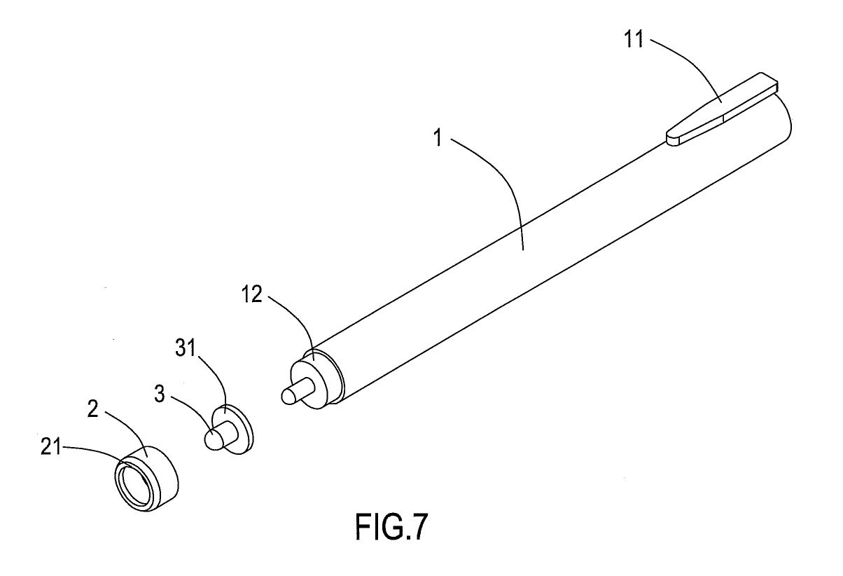

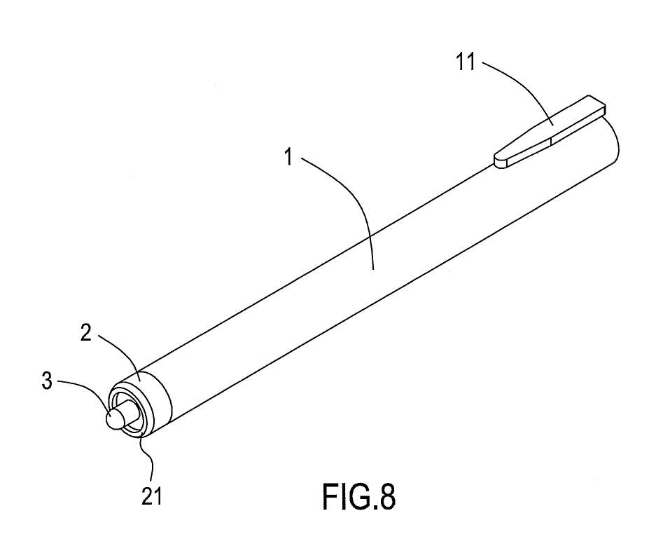

Referring to FIG. 7 and FIG. 8, it shows a three-dimensional exploded view and a three-dimensional assembly view of another replaceable touch pen, according to the present invention. The replaceable touch pen comprises an electro-conductive barrel 1, a fixing member 2 and an electro-conductive nib 3.

The electro-conductive barrel 1 is made by a plastic material and the color of the electro-conductive barrel 1 can be changed through conducting paint to increase the diversity of color of the electro-conductive barrel 1. In addition to being in a circular shape as shown in the drawings, the electro-conductive barrel 1 can be in a triangular or rectangular shape to increase the practicality of the product. The outer rim of the electro-conductive barrel 1 can be connected with a clipping member 11 and a slit is formed between the clipping member 11 and the electro-conductive barrel 1, allowing the user to clip and fix the electro-conductive barrel 1 on a clothes. The front end of the electro-conductive barrel 1 is formed with a connection portion 12.

The fixing member 2 is an annular and hollow structure. An end of the fixing member 2 is interconnected and locked with the connection portion 12 of the electro-conductive barrel 1 by snapping or screwing, allowing the fixing member 2 to be locked at the front end of the electro-conductive barrel 1 after connection. The other end of the fixing member 2, on the other hand, is bended inward with a positioning portion to clip and position the electro-conductive nib 3 on the electro-conductive barrel 1.

The electro-conductive nib 3 is made by an elastic material, such as electro-conductive plastic, electro-conductive rubber or electro-conductive foam. The bottom of the electro-conductive nib 3 is extended outward with an extension portion 31 corresponding to the positioning portion 21 of the fixing member 2, such that when the electro-conductive nib 3 is transfixed into the fixing member 2, it can be positioned on the positioning portion 21 of the fixing member 2 through the extension portion 31. Therefore, the electro-conductive nib 3 can be fixed at the front end of the electro-conductive barrel 1 through the fixing member 2, so as to avoid the fracture to the electro-conductive nib 3 by an inappropriate force when the user is operating the touch pen.

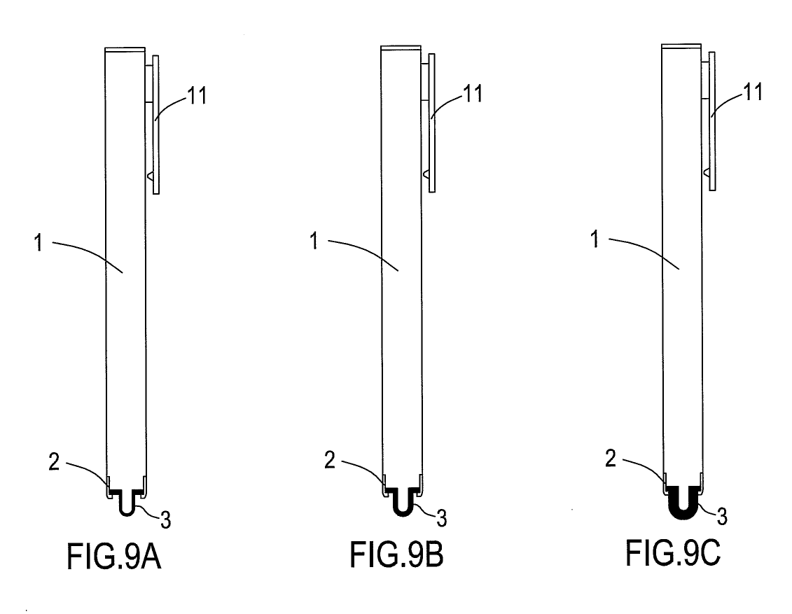

Referring to FIG. 9A, FIG. 9B and FIG. 9C at a same time, it shows a schematic view of a small-sized electro-conductive nib, a schematic view of a medium-sized electro-conductive nib and a schematic view of a large-sized electro-conductive nib, of the replaceable touch pen, according to the present invention. It can be seen through the abovementioned structures that as the electro-conductive nib 3 is positioned and fixed with the positioning portion 21 of the fixing member 2 through the extension portion 31, the electro-conductive nib 3 can be divided into a large size, a medium size and a small size, etc. Through the electro-conductive nibs 3 of various sizes, the present invention can be applied to a variety of electronic products.

It is of course to be understood that the embodiments described herein is merely illustrative of the principles of the invention and that a wide variety of modifications thereto may be effected by persons skilled in the art without departing from the spirit and scope of the invention as set forth in the following claims.

What is claimed is:

1. A replaceable touch pen comprising an electro-conductive barrel made by a plastic material, a front end of the electro-conductive barrel being formed with a connection portion; an annular and hollow fixing member, an end of the fixing member being interconnected and locked with the connection portion of the electro-conductive barrel and the other end of the fixing member fixing the electro-conductive nib, allowing the electro-conductive nib to be stably connected on the fixing member.

2. The replaceable touch pen according to claim 1, wherein the fixing member is interconnected with the electro-conductive barrel by snapping or screwing.

3. The replaceable touch pen according to claim 1, wherein the front end of the electro-conductive barrel is covered by a cap.

4. The replaceable touch pen according to claim 1, wherein the electro-conductive nib is extended with an extension portion, the electro-conductive nib is divided into many different sizes and the fixing member is bended with a positioning portion corresponding to the extension portion; through positioning and fixing the extension portion with the positioning portion, the electro-conductive nib being fixed at the front end of the electro-conductive barrel.

5. The replaceable touch pen according to claim 1, wherein the electro-conductive nib is made by electro-conductive plastic, electro-conductive rubber or electro-conductive foam.

6. The replaceable touch pen according to claim 4, wherein the electro-conductive nib is made by electro-conductive plastic, electro-conductive rubber or electro-conductive foam.

7. The replaceable touch pen according to claim 1, wherein the electro-conductive barrel is in a triangular, circular or rectangular shape.

8. The replaceable touch pen according to claim 2, wherein the electro-conductive barrel is in a triangular, circular or rectangular shape.
